(19) United States
(12) Patent Application Publication
(10) Pub. No.: US 2025/0075741 A1
(43) Pub. Date: Mar. 6, 2025

(54) METHOD FOR PROLONGING THE LIFE OF A PRODUCT AND A REMANUFACTURED PRODUCT

(71) Applicant: AKTIEBOLAGET SKF, GOTEBORG (SE)

(72) Inventors: Guillermo Enrique MORALES ESPEJEL, Ijsselstein (NL); Armando FELIX QUIÑONEZ, IJsselstein (NL)

(21) Appl. No.: 18/729,597

(22) PCT Filed: Jan. 25, 2023
(86) PCT No.: PCT/EP2023/051770

§ 371 Date: Jul. 17, 2024

(30) Foreign Application Priority Data
Feb. 8, 2022 (DE) 102022201310.7

(51) Int. Cl. F16C 33/64; F16C 19/06

(52) U.S. Cl. CPC F16C 33/64; F16C 19/06; F16C 2223/06; F16C 2235/00; F16C 2237/00; F16C 2240/60; F16C 2300/14

(57) ABSTRACT

A method for prolonging the service life of a product that is subjected to Hertzian contact stress when in use, and which includes a metal surface having at least one indentation, includes removing a first portion of the at least one indentation from the metal surface to provide a remanufactured product having a remanufactured metal surface having a second portion of the at least one indentation, obtaining information about the second portions of the at least one indentation, using the information to estimate potential stress concentrations that are detrimental to lubrication conditions and/or fatigue life of the remanufactured metal surface using analytical modelling, and providing a prediction of the performance of the remanufactured product based on the estimation.

### TECHNICAL FIELD

The present invention concerns a method for prolonging the life of a product, such as a machine component, that is subjected to Hertzian contact stress when in use, i.e. Hertzian contact stress or pseudo-Hertzian contact stress when lubrication is included, and which includes a metal surface that comprises at least one indentation. The present invention also concerns a remanufactured product that has been subjected to a method according to such a method.

### BACKGROUND OF THE INVENTION

Indentations in products, such as rolling bearing raceways and rolling elements, are known to be a source of surface damage resulting in shorter service life.

The article by H.-Jürgen Böhmer and Reiner Eberhard entitled “Microstructural Optimisation of Bearing Steels for Operation Under Contaminated Lubrication by Using the Experimental Method of Dented Surfaces”, published in Bearing Steel Technology ASTM STP 1419, on pages 244-262, by the American Society for Testing and Materials International (2002), describes an experimental investigation of the damage mechanisms of anti-friction bearings operating under debris-contaminated lubrication.

The authors of the article disclose that particles in debris-contaminated lubrication which enter the contact zone of a bearing may get pressed into the surface of a bearing during the use of the bearing. The incorporation of a particle into the bearing material results in the formation of a plastically deformed zone around the particle, and raised edges (referred to a “shoulder”) at the bearing surface. This leads to the formation of an indentation having a crater that extends below the surface of the bearing material, i.e. below the mean raceway profile, and a shoulder around the perimeter of the indentation that extends above the surface of the bearing material, i.e. above the mean raceway profile. The shoulders may create metal-to-metal contact between the indented raceway surface and a counter surface, especially in cases where a shoulder rises above a bearing's lubrication film. Such metal-to-metal contact can lead to high stress concentration at, or within the shoulders of indentations, which imparts a high risk of component failure.

Repeated over-rolling of the shoulders of an indentation can namely initiate the formation of cracks due to material fatigue. The cracks generated at the shoulders of indentations can then propagate below the bearing raceway close to the raceway surface, before they reach the raceway surface again. The material between a crack and the raceway surface may eventually break away, leaving a spall which increases in size with continued over-rolling, and one or more cracks that continue to propagate in the rolling direction. The result is typically a V-shaped spall immediately behind the indentation.

If the indentation is too large, the product has to be scrapped and replaced with a new product. If the size of an indentation is not too large, the product may however be remanufactured by machining the indented metal surface to remove the indentation, i.e. the metal surface may be machined to remove the crater and shoulder(s) of the indentation to provide a flat and indentation-free surface so that the remanufactured product can continue to be used.

Small indentations are usually removed by polishing and larger indentations are usually removed by grinding.

Polishing is a surface treatment process for creating a smooth surface using a loose abrasive that is driven by another material (such as a polishing compound driven by a work wheel or work plate) or by a person. The width of material removed from bearing raceways is generally between 5 and 20 μm.

Removing a wider layer of material may need more time and possibly a specific process, which may have a significant impact on the cost.

Applying a controlled remanufacturing process before any major damage or component failure occurs can prolong the service life of the component, reducing total life cycle costs, lead times and machine downtime. Additionally, since a remanufacturing process requires less energy than manufacturing a new component, it is better for the environment. Further environmental benefits of remanufacturing include significant savings in terms of resources and waste.

When components with indented surfaces are sent for remanufacturing, the size of the indentations may however require a relatively complex, time consuming and expensive process for their removal, which often means that the component has to be sent to a specialized remanufacturing site, which reduces the carbon dioxide emission-saving that remanufacturing entails. Furthermore, the removal of indentations may sometimes require the replacement of part of a component, such as the replacement of a complete roller set of a bearing, to compensate for the different internal geometry resulting from the remanufacturing process. This often means that an operator may decide to scrap an indented product and replace it with a new product rather than remanufacturing it depending on the cost of the new component and the size of the indentations on the indented component.

Typically, only large components are considered as candidates for remanufacturing.

Analytical models that estimate potential stress concentrations that are detrimental to lubrication conditions and/or fatigue life of surfaces, such as rolling bearing raceways, and which may be used to provide a prediction of the performance of the rolling bearing are well known. The skilled person is familiar with the principles on which such models are based.

For example, the article entitled “A model for rolling bearing life with surface and subsurface survival: Sporadic surface damage from deterministic indentations” by Guillermo E. Morales Espejel and Antonio Gabelli (published in Tribology International, v 96, p 279-288, 2016) discloses a rolling bearing life model with the ability to separate the survival probability of the raceway surface from the subsurface fatigue risk of the rolling contact applied to the case of sporadic and geometrically defined plastic indentations of the raceway, which is the case in bearings lubricated with oil containing very few metallic particles.

The authors of the article studied the effect of sporadic deterministic indentations on the expected life of the bearings using analytical modelling and by conducting extensive endurance life testing experiments on bearings with pre-indented raceways. The article discloses an indented surface fatigue model which is based on a surface-subsurface fatigue risk approach. The model results were validated by comparing the predicted fatigue lives with a large number of endurance tests of bearing population samples subjected to different contact pressures and damaged with indentations of different sizes and shapes. The model was used to study the effect of the indentation size, load and lubrication of pre-indented bearings. In this study it was found that the lubrication quality of the rolling contact has a strong effect on the life reduction of bearings with indentation damage. This was found to correlate well with the evolution and morphology of the indentation damage observed during experimental testing.

### SUMMARY OF THE INVENTION

An object of the invention is to provide an improved method for prolonging the service life of a product that is subjected to Hertzian contact stress when in use and which includes a metal surface, i.e. at least one metal surface, comprising at least one indentation.

This object is achieved by a method comprising the features recited in claim 1. The method comprises the steps of: removing at least part of the at least one indentation from the metal surface to provide a remanufactured product having a remanufactured metal surface comprising at least part of one or more indentations remaining on the remanufactured metal surface, obtaining information about the at least part of one or more indentations remaining on the remanufactured metal surface, from a visual inspection for example, and using that information for estimating potential stress concentrations that are detrimental to lubrication conditions and/or fatigue life of the remanufactured metal surface using analytical modelling, and providing a prediction of the performance of the remanufactured product based on the estimation.

There is currently no tool or method for estimating the performance of a remanufactured product that comprises at least one remanufactured metal surface comprising at least part of one or more indentations because products are normally remanufactured so that a remanufactured metal surface does not comprise any indentations or parts of indentations. All indentations created during the use or the product, in non-clean conditions for example, and/or during the manufacture and/or transportation of the product have conventionally been removed during a remanufacturing process leaving a smooth defect-free surface.

The inventors have found that the performance of a remanufactured product that comprises at least one remanufactured metal surface that comprises at least part of one or more indentations after it has been subjected to the simple and cost-effective remanufacturing step of a method according to the present invention is however similar to the performance of a product from which all indentations, i.e. all parts of all indentations, have been removed. The performance of a remanufactured product compared to a new product will however depend on the number and size of the one or more craters remaining in the remanufactured surface and also on external parameters, such as load.

Furthermore, the method according to the present invention leads to a carbon dioxide emission-saving compared with replacing an indented product with a new product.

The method according to the present invention enables an operator to compare the performance of the remanufactured product to the performance of a new product, which also allows the effect of the remanufacturing to be evaluated.

The term “remanufacturing” as used in this document is intended to mean not only a remanufacturing process step, but applies to all similar process steps, such as process steps aiming to refurbish, recondition, repurpose, restore and/or repair products.

According to an embodiment of the invention the metal surface has a mean surface profile and comprises at least one indentation that has a shoulder extending above the mean surface profile and a crater extending below the mean surface profile, whereby the step of removing at least part of the at least one indentation comprises removing at least part of the shoulder, or the whole shoulder, but leaving at least part of the crater, such that a remaining part of the crater extends from the mean surface profile, to thereby provide a remanufactured metal surface. Such a method, which only the part of an indentation that is predominantly responsible for component failure, rather than the whole indentation, provides a much simpler, faster and more cost-efficient remanufacturing process than a remanufacturing processes which remove the whole indentation.

In the case where there is a single indentation in a metal surface of a product that is to be subjected to remanufacturing, the expression “removing at least part of the shoulder, but leaving at least part of the crater” as used throughout this document is intended to mean that at least part of a shoulder or the whole shoulder of that single indentation is removed.

In the case where there is a plurality of indentations in a metal surface of a product that is to be subjected to remanufacturing, the expression “removing at least part of the shoulder, but leaving at least part of the crater” as used throughout this document is intended to mean that at least part of all of the shoulders or all of the shoulders of all of the indentations in the metal surface are removed, but at least part of the crater of the largest crater in the indented metal sheet, or at least parts of the largest craters of the plurality of indentations in the indented metal sheet remain after the product has been subjected to a remanufacturing step of the method according to the present invention. This means that at least one, some, or all of the craters other than the crater or craters of the largest crater or craters may be removed in their entirety.

An indented metal surface can namely comprise one or more indentations of any shape and size depending on the size, geometry and hardness of the particles that are entrapped in the contact area between the product and another component when the product is in use, although very large particles are not entrapped, and very small particles go through the lubricant film without causing indentations. Soft or malleable (ductile) particles (fibre or metal) produce shallow indentations with shoulders. Brittle, hard particles shatter into many very small particles and produce a cluster of tiny indentations. Friable tough particles produce a large agglomerate of material that dents the metal surface, producing sharp shoulders. Indentations of a large size, or which have large shoulders are the most dangerous.

According to an embodiment of the invention, at least one entire shoulder is removed, i.e. 100% of the shoulder, i.e. 0% of the crater is removed, or up to 5%, or up to 10%, or up to 20%, or up to 30%, or up to 40% or up to 50% of the crater is removed. Any crater that remains in the remanufactured metal surface is preferably smaller than the original crater in the indented metal surface. Alternatively, at least 50%, or at least 60%, or at least 70%, or at least 80%, or at least 90% or at least 95% of a should us removed and 0% of the crater is removed.

The expression “mean surface profile” as used herein is intended to mean the surface profile that represents the intended surface contour and desired specifications of the product as manufactured. A mean surface profile will not be geometrically perfect but will not have any surface irregularities that extend beyond manufacturing tolerances. The expressions “shoulder” and “crater” of an indentation refer to irregularities that do extend beyond manufacturing tolerances.

According to an embodiment of the invention, the step of removing at least part of a shoulder, but leaving at least part of a crater may be accomplished using any suitable process, such as at least one of the following: polishing, buffing, electropolishing, cutting, flattening, heat treatment, grinding, honing.

Any suitable surface treatment process that removes at least part of the shoulder of an indentation but does not remove material from the metal surface of a component thereby changing the shape of a component may be used in the method according to the present invention.

According to an embodiment of the invention the method comprises a step of determining or estimating a dimension or size of the crater, such as the volume, cross-sectional area, depth and/or maximum width of the crater, and conducting the remanufacturing step of the method only if the determined or estimated dimension or size is less than a predetermined critical dimension or size. A dimension or size of the crater may be determined or estimated by visual inspection, using an optical microscope for example, or measurement using a device and/or an operator's knowledge and/or experience and will depend on the product in question.

According to an embodiment of the invention the step of remanufacturing the product by removing at least part of the shoulder but leaving at least part of the crater comprises removing only a microscopic layer of material having a thickness of up to and including 50 μm from the metal surface, or up to and including 40 μm, or up to and including 30 μm, or up to and including 20 μm, such as a layer of material having a thickness of 5-50 μm or 10-50 μm. Such a microscopic layer of material is preferably removed from the entire metal surface that is being remanufactured. The removal of such a thin surface layer does not change the macrogeometry of the product, such as the diameter or circumference of a product. The removal of material is namely so small as to be visible only with a microscope.

According to an embodiment of the invention the step of remanufacturing the product by removing at least part of a shoulder but leaving at least part of a crater comprises removing a layer of material having a thickness of more than 50 μm, such as a layer of material having a thickness of up to 100 μm or more.

According to an embodiment of the invention the information about the at least part of one or more indentations remaining on the remanufactured metal surface comprises information regarding one or more of the following: a total number of indentations, a geometry of one or more indentations, such as a crater depth, width or maximum width, cross sectional area.

According to an embodiment of the invention the step of estimating potential stress concentrations that are detrimental to lubrication conditions and/or fatigue life of the remanufactured metal surface using analytical modelling is based on separation of product surface and subsurface survival to provide an estimation. A model, using the principles outlined in the article entitled “A model for rolling bearing life with surface and subsurface survival: Sporadic surface damage from deterministic indentations” by Guillermo E. Morales Espejel and Antonio Gabelli (published in Tribology International, v 96, p 279-288, 2016) may namely be used in a method according to the present invention.

This article discloses a rolling bearing life model in which each individual indentation is analysed and its effect explicitly accounted in the penalisation of the raceway surface survival. Information, such as geometrical parameters of each indentation in the raceway are obtained, such as the diameter, length, shoulder height and depth. The separation of the risks between the surface and subsurface allows sophisticated tribological models for the analysis of the surface induced stresses to be adopted.

Such a model can estimate remanufactured product life effects of the detailed geometry-related stress risers present on a remanufactured metal surface as indentations. The model can account for the operating conditions of the product, such as load and lubrication conditions as well as product geometry.

The separation of surface and subsurface damage evaluation can be used to develop remanufactured product life assessment methodologies useful in complex tribological phenomena affecting the life of products, such as indentations of deterministic geometry, grooves and other surface stress risers present on a remanufactured metal surface. As a consequence of the use of such methodologies and the separation of the surface from of the subsurface, the surface damage risk parameter can be calculated, giving a unique simple measure of the significance of the remanufactured surface damage in relation to the fatigue risk of the entire remanufactured product. For the case of indentations, the methodologies can deal with sporadic dents or grooves of different sizes and geometry. The lubrication conditions are may also be included. Poorly lubricated bearings with indentations are namely more prone to failure than the same bearings under good lubrication. Models that ignore this interaction are not as accurate as models that include lubrication conditions.

According to an embodiment of the invention the method comprises a step of creating documentation comprising the prediction of the performance of the remanufactured product. The documentation may comprise at least one of the following: a paper record, an electronic record, a software record, a database record, notification provided on the remanufactured product.

According to an embodiment of the invention the method comprises a step of repeating the step of removing at least part of the at least one indentation from the metal surface if the prediction of the performance of the remanufactured product is below a predetermined threshold performance. Such a method may be used to determine whether a remanufactured product has been sufficiently remanufactured for a particular application or whether it should be subjected to further remanufacturing so as to further improve its performance before it is sent to an operator for further use.

The present invention also concerns a remanufactured product comprising at least one remanufactured metal surface that is subjected to Hertzian contact stress when in use. The remanufactured product has a at least one remanufactured metal surface comprising at least part of one or more indentations remaining on the remanufactured metal surface. At least part of one or more indentations that were present before the product were remanufactured are still namely present in the remanufactured product. The remanufactured product has for example been subjected to a method according to the embodiments according to the present invention. The remanufactured product comprises and/or is associated with documentation that includes a prediction of the performance of the remanufactured product that is based on an estimation of potential stress concentrations that are detrimental to lubrication conditions and/or fatigue life of the remanufactured metal surface obtained from information concerning one or more indentations remaining on the remanufactured metal surface and using analytical modelling.

According to an embodiment of the invention the product is one of the following: a bearing component, such as an inner or outer bearing ring or rolling element, a bearing raceway or any rolling bearing, such as a needle bearing, a tapered roller bearing, a spherical roller bearing, a toroidal roller bearing, a ball thrust bearing, a roller thrust bearing, a tapered roller thrust bearing, a wheel bearing, a hub bearing unit, a Compact Aligning Roller Bearing (CARB™), a Deep Grove Ball bearing, an angular contact ball bearing, a spherical roller bearing used in a continuous caster line, a backing bearing, a slewing bearing or a ball screw, a transmission component, such as a sprocket, a gear, a bushing, a hub, a coupling, a bolt, a screw, a shaft, such as a spindle shaft, a roller or roller mantle, a seal, a tool, a metal wheel, or any other component for an application in which it is subjected to Hertzian contact stress, or alternating Hertzian contact stress. Any remanufactured product may namely be subjected to a method according to an embodiment of the invention.

### BRIEF DESCRIPTION OF THE DRAWINGS

The present invention will hereinafter be further explained by means of non-limiting examples with reference to the appended figures where;

FIG. 1 shows an example of a product that can be subjected to a method according to an embodiment of the invention,

FIG. 2 shows a two-dimensional profile of an indentation in a metal surface before and after the metal surface has been subjected to a remanufacturing step of a method according to the present invention, and

FIG. 3 is a flow chart showing the steps of a method according to an embodiment of the invention.

It should be noted that the drawings have not necessarily been drawn to scale and that the dimensions of certain features may have been exaggerated for the sake of clarity.

### DETAILED DESCRIPTION OF EMBODIMENTS

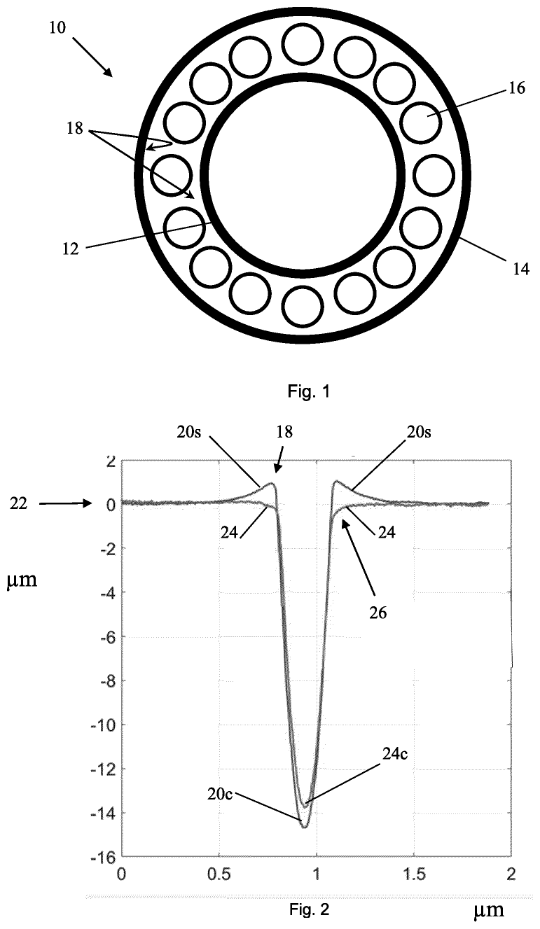

FIG. 1 schematically shows a product 10, namely a rolling element bearing, a metal surface 18 of which may be subjected to a method according to an embodiment of the invention.

A metal surface 18 may comprise or consist of any pure metal, such as iron, nickel, titanium, copper, aluminium, tin or zinc, or any metal alloy, such as steel, carbon steel, stainless steel, a nickel-based superalloy, a titanium alloy, brass or bronze.

A product 10 may be any type of bearing, such as a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a Compact Aligning Roller Bearing (CARB™), a Deep Grove Ball bearing, an angular contact ball bearing, a spherical roller bearing used in continuous caster lines, backing bearing, slewing bearing or a ball screw, or any other product that is subjected to Hertzian contact stress when in use.

A product 10 may have a diameter up to a few metres in size and have a load-carrying capacity up to many thousands of tonnes. A product 10 may namely be of any size and have any load-carrying capacity. The product 10 may be used in industries such as metals, mining, mineral processing, cement, automotive, renewable or traditional energy, pulp or paper, or marine.

The illustrated rolling element bearing 10 has an inner ring 12 and an outer ring 14 and a set of rolling elements 16. Indentations may appear in the rolling bearing's raceways 18 during the use of the rolling element bearing 10. The over-rolling of solid particles (from contaminated lubricant for example) can namely produce surface indentations of raceways 18 in the rolling-sliding lubricated contacts.

FIG. 2 schematically shows a two-dimensional profile of two indentations 20 and 24 which have been superimposed and aligned along a line that corresponds to 0 on the y-axis, whereby the units shown on the x- and y-axis are microns.

Indentation 20 represents the sole indentation, the largest indentation or one of the largest indentations in an indented metal surface 18 of a product 10 before the indented metal surface is subjected to a remanufacturing step of the method according to the present invention.

Indentation 24 represents the part of the indentation that is left in a remanufactured metal surface 26 after the indented metal surface has been subjected to a method according to the present invention, i.e. after the entire indented metal surface 18 has been remanufactured, by polishing for example.

Since a microscopic layer of material is removed during the method according to the present invention, the remanufactured metal surface will be microscopically lower than the indented metal surface 18. For example, if an indented raceway of a bearing is subjected to a method according to the present invention, the remanufactured raceway depth may be up to 50 μm lower than the indented raceway depth. This slight difference can be seen since the indentations 20 and 24 are superimposed and aligned along the line that corresponds to 0 on the y axis in FIG. 2.

The mean surface profile 22 of the metal surface 18 may be considered to be the line that corresponds to 0 plus or minus 0.1 units on the y-axis in FIG. 2, whereby ±0.1 unit corresponds to the manufacturing tolerance.

The indentation 20 in the indented metal surface 18 has a shoulder 20s that extends above the mean surface profile 22 and a crater 20c that extends below the mean surface profile 22. A shoulder 20s may for example extend up to 50 μm above the mean surface profile 22. A shoulder 20s may form unevenly around the perimeter of an indentation 20, so that one or more portions of the shoulder 20s may be higher than one or more other portions of the shoulder 20s.

The indentation 24, which is left in the metal surface 18 after the metal surface 18 has been subjected to a remanufacturing step of a method according to the present invention, comprises only a crater 18c and no shoulders since the shoulders 20c of the indentation 20 have been removed and the remanufactured metal surface is flush with the mean surface profile 22, i.e. flush with the remainder of the metal surface 18 within manufacturing tolerances. There is therefore no longer any material that extends above the mean surface profile 22 at the location 24 where the shoulder 24s was located after the metal surface has been subjected to a method according to the present invention. At least part 24c of the crater 20c of the indentation 20 is however still left in the metal surface 18. The size of the remaining crater 24c will not however adversely affect the performance of the remanufactured product. The remanufactured metal surface is namely a flat surface which has smaller differences between its highest and lowest points compared to an indented metal surface before it is subjected to the method according to the present invention, meaning there are fewer microscopic stress concentrations where a crack can be initiated, thereby improving fatigue life of the product 10.

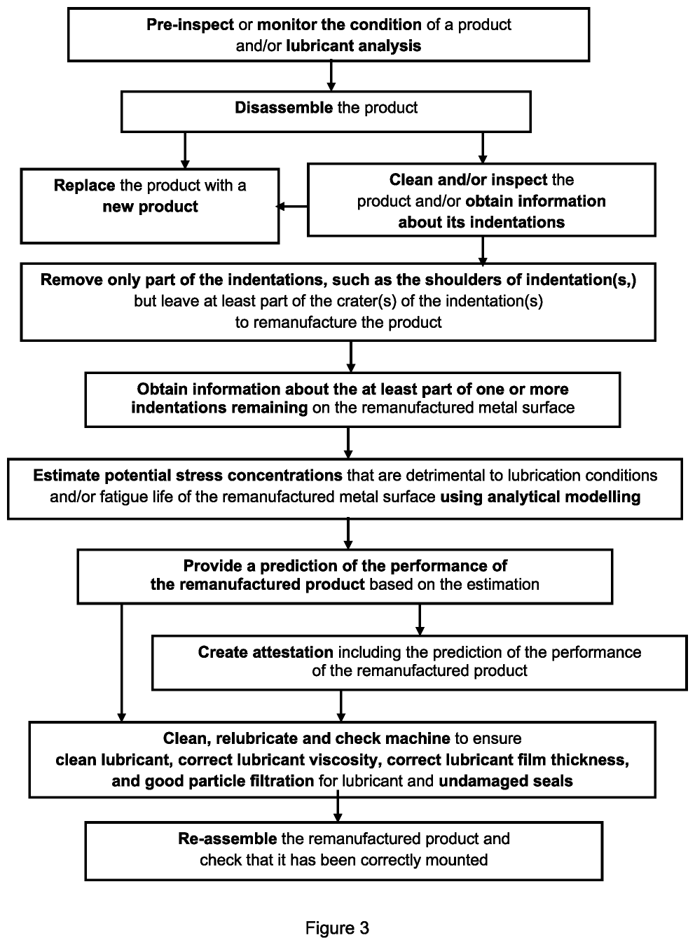

FIG. 3 is a flow chart showing the steps of a method according to the present invention. The method comprises the steps of optionally pre-inspecting and/or monitoring the condition of product 10 to see whether it comprises any indentations 20 comprising a shoulder 20c and a crater 20c in which the crater 20c has a dimension or size that is greater than a predetermined critical dimension. A crater 20c may for example have a maximum width at the surface of the metal surface 18 that is greater than a predetermined maximum width and/or a maximum cross-sectional area at the metal surface 18 that is greater than a predetermined maximum cross-sectional area).

At least one indentation 20 may be formed during the use, manufacture, assembly, mounting and/or transportation of the product 10. The method according to the present invention may optionally comprise the step of analyzing a machine's lubricant or lubrication system to determine whether a product 10 may comprise at least one indentation 20.

If a product 10 comprises at least one indentation 20 having a dimension or size greater than a predetermined critical dimension or size, it may optionally be cleaned and/or inspected more carefully after disassembling the product 10 from a machine in which it is mounted if it is mounted in a product. Information about the indentation(s) in a metal surface 18 of the product 10 may be obtained, by visual inspection and/or measurement using any suitable means, to determine whether the product is a candidate for remanufacturing using a method according to the present invention.

If the indented product 10 comprises at least one indentation having a crater that is greater than a predetermined critical dimension or size, the indented product 10 may be scrapped and replaced with a new product 10. For example, if a two-dimensional cross-sectional area of a crater 20c is greater than the contact area between the product 10 and another component when the product 10 is in use, the indented product 10 may be scrapped and replaced with a new product. The predetermined critical dimension or size will depend on the size of the product 10 and the load to which it is subjected during use and is known to the skilled person. Normally, it is the size or volume of a crater 20c of an indentation that is important as regards the decision of whether to remanufacture the product 10 or not, and not its depth.

If the indented product 10 comprises only one or more indentations 20 having a crater 20c that is less than a predetermined critical dimension or size, the service life of the indented product 10 may be prolonged by remanufacturing the indented metal surface of the indented product using a method according to the present invention 10. An indented metal surface 18 of the product 10 may namely be surface-treated, by polishing for example, so as to remove at least part of the shoulders 20s of the one or more indentations 20, but so as to at least part of a crater 20c of the sole indentation 20 in the indented metal surface 18, or of the largest indentation 20 in the indented metal surface 18, such that the remaining part 24c of the crater 24c extends from the mean surface profile 22 of the remanufactured metal surface 26 which comprises an indentation 24 having only a crater 24c that has a dimension or size that is less than the predetermined critical dimension or size, but no shoulder.

The crater 24c of an indentation 24 remaining in the remanufactured metal surface 26 may be at least 50%, or at least 60%, or at least 70%, or at least 80%, or at least 90%, or 100% of the size of the crater 20c of the indentation 20 in the indented product 10 (measured from the mean surface profile 22 of the metal surface 18, and not from the tip of the shoulder 20s of the indentation 20) before the indented product 10 is subjected to a remanufacturing step of a method according to the present invention.

The thickness of the surface layer of the indented metal surface 18 of the product 10 which is removed during the method according to the present invention depends on the size of the indentation or the largest indentation(s) in the indented metal surface 18. One or more indentations that are smaller than the largest indentation(s) may be completely removed, but at least part 24c of a crater 20c will remain in the remanufactured metal surface 26. The size of the remaining part 24c of any crater in the remanufactured metal surface 26 can optionally be checked to ensure that the remaining part 24c of any crater will not adversely affect the performance of the remanufactured product.

An indented product 10 may be polished so as to remove only a microscopic layer of material having a thickness of up to 50 μm from its metal surface 18.

Once a remanufactured metal surface 26 has been provided, the method comprises the step of obtaining information about the at least part (24c) of one or more indentations remaining on the remanufactured metal surface 26. The information may comprise information regarding one or more of the following: a total number of indentations, a geometry of one or more indentations, such as a crater depth, width or maximum width, cross sectional area.

The information is used for estimating potential stress concentrations that are detrimental to lubrication conditions and/or fatigue life of the remanufactured metal surface in analytical modelling, and a prediction of the performance of the remanufactured product based on the estimation is then provided.

Optionally, the method comprises the step of creating documentation comprising the prediction of the performance of the remanufactured product. The documentation may comprise at least one of the following: a paper record, such as a certificate or label, an electronic record, a software record, a database record, a notification provided on the remanufactured product, such as a Quick Response (QR) code, a mark, lettering, or a number that is provided on part of the remanufactured product. The documentation may be provided to an operator together with the remanufactured product and/or be accessible to an operator via a database for example.

Estimations and/or predictions provided by a method according to the present invention may be included in documentation associated with a remanufactured product. Documentation may optionally include information that enables an operator to trace processes from the procurement of raw materials to production, consumption and disposal of a product for improved traceability.

Once a product 10 has been subjected to a method according to the present invention, the remanufactured product may then be assembled or re-assembled in a product.

Optionally, and preferably, the machine in which a remanufactured product is mounted is cleaned, and/or lubricated or re-lubricated with clean lubricant, and/or checked to ensure good particle filtration for lubricant, correct lubricant viscosity and/or correct lubricant film thickness and/or undamaged seals before a remanufactured product is mounted in the product. Such checks may be carried out at any suitable time before, during and/or after the use of a remanufactured product.

Optionally, and preferably, once a remanufactured product has been mounted in a machine, the method comprises the step of checking whether the remanufactured product has been correctly mounted. Such a step should be carried out even when using of a new product 10 to prevent the formation of at least one indentation 20 and maximize the service life of the product 10.

It should be noted that a method according to the present invention may be used for prolonging the service life of a particular product 10 more than once, i.e. the method may be used to prolong the service life of a product 10 a plurality of times. The method may for example be used to remove at least the shoulders of indentations until or after such a removal of at least the shoulders of indentations requires the replacement of some part of the product, such as the replacement of a complete roller set if a roller bearing, to compensate for the different internal geometry resulting from the remanufacturing process.

The condition of a new or remanufactured product may be monitored so that the full benefits of the method according to the present invention can be achieved by conducting the method at an optimum time before a new or remanufactured product is damaged to a degree that does not allow subsequent remanufacturing.

Further modifications of the invention within the scope of the claims would be apparent to a skilled person.

1. A method for prolonging the service life of a product that is subjected to Hertzian contact stress when in use and which includes a metal surface having at least one indentation, the method comprising:
removing a first portion of said at least one indentation from said metal surface to provide a remanufactured product having a remanufactured metal surface having a second portion of the at least one indentation,
obtaining information about the second portion of the at least one indentation,
using said information to estimate potential stress concentrations that are detrimental to lubrication conditions and/or fatigue life of said remanufactured metal surface using analytical modelling, and
providing a prediction of the performance of said remanufactured product based on said estimation.

2. The method according to claim 1,
wherein said metal surface has a mean surface profile,
wherein a first one of said at least one indentation has a shoulder extending above said mean surface profile and a crater extending below said mean surface profile,
wherein removing at least part of the first one of said at least one indentation comprises removing at least part of said shoulder, but leaving at least part of said crater, such that a remaining part of said crater extends from said mean surface profile.

3. The method according to claim 1, wherein said information about the second portions of the at least one indentation comprises information regarding one or more of the following: a total number of the second portions of the at least one indentation, a geometry of one or more second portions of the at least one indentation, and a depth, width, maximum width, or cross sectional area of the second portions of the at least one indentation.

4. The method according to claim 1, wherein using said information to estimate potential stress concentrations is based on separation of product surface and subsurface survival.

5. The method according to claim 1, including creating documentation comprising said prediction of the performance of said remanufactured product.

6. The method according to claim 5, wherein the documentation comprises at least one of the following: a paper record, an electronic record, a software record, a database record, or indicia provided on said remanufactured product.

7. The method according to claim 1, including removing part of the second portion of the at least one indentation if said prediction below a predetermined threshold performance.

8. The method according to claim 1, wherein removing a first portion of said at least one indentation comprises at least one of the following actions: polishing, buffing, electropolishing, cutting, flattening, heat treatment, grinding, honing.

9. A remanufactured product comprising at least one remanufactured metal surface that is subjected to Hertzian contact stress when in use, wherein said remanufactured product has a at least one remanufactured metal surface including at least part of one or more indentations remaining on said remanufactured metal surface, and comprises and/or is associated with documentation that includes a prediction of the performance of said remanufactured product that is based on an estimation of potential stress concentrations that are detrimental to lubrication conditions and/or fatigue life of said remanufactured metal surface obtained from information concerning one or more indentations remaining on said remanufactured metal surface using analytical modelling.

10. The remanufactured product according to claim 9, wherein said remanufactured product is selected from the group consisting of: a bearing component, a bearing raceway, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a Compact Aligning Roller Bearing (CARB™), a Deep Grove Ball bearing, an angular contact ball bearing, a spherical roller bearing configured for use in a continuous caster line, a backing bearing, a slewing bearing, a ball screw, a sprocket, a gear, a bushing, a hub, a coupling, a bolt, a screw, a shaft, a roller or roller mantle, a seal, a tool, and a metal wheel.

11. A method for prolonging the service life of a product that is subjected to Hertzian contact stress when in use and which includes a metal surface having a plurality of damaged regions each comprising a crater having a shoulder at an end of the crater, the method comprising:
processing the metal surface to remove the shoulders and a first part of each of the craters to produce a remanufactured surface having a plurality of reduced-depth craters,
obtaining information about the plurality of reduced-depth craters,
using said information to estimate potential stress concentrations that are detrimental to lubrication conditions and/or fatigue life of said remanufactured metal surface using analytical modelling,
providing a prediction of the performance of said remanufactured product based on said estimation,
further processing the remanufactured surface to further reduce the depth of the reduced- depth craters if the prediction is below a predetermined threshold, and
associating documentation of the prediction with the product.
